(19) United States
(12) Patent Application Publication
(10) Pub. No.: US 2026/0168905 A1
(43) Pub. Date: Jun. 18, 2026

(54) INFORMATION PROCESSING DEVICE AND INFORMATION PROCESSING METHOD

(71) Applicant: Panasonic Intellectual Property Management Co., Ltd., Osaka (JP)

(72) Inventors: NAOKI NOJIRI, Osaka (JP); HIDEAKI HAMADA, Hyogo (JP); MITSUO SAITOH, Osaka (JP); SATORU KISHIMOTO, Kyoto (JP)

(21) Appl. No.: 19/534,566

(22) Filed: Feb. 9, 2026

Related U.S. Application Data
(63) Continuation of application No. PCT/JP2024/032512, filed on Sep. 11, 2024.

(30) Foreign Application Priority Data
Oct. 20, 2023 (JP) 2023-181180

(51) Int. Cl. G01N 3/42; G01B 5/06

(52) U.S. Cl. CPC G01N 3/42; G01B 5/06

(57) ABSTRACT

An information processing device includes a processor that estimates a state of a workpiece to be processed by a processing device that repeatedly performs processing, and a storage device that stores an operation parameter for estimating the state of the workpiece. The processor acquires waveform data indicating a measurement result of a transition of a processing load in a processing cycle by the processing device, and estimates at least one of hardness and thickness of the workpiece as the state of the workpiece based on a height of the waveform indicated by the waveform data, a width of the waveform, and the operation parameter.

### TECHNICAL FIELD

The present disclosure relates to an information processing device and an information processing method.

### BACKGROUND ART

PTL 1 discloses a technique of obtaining a determination value by synthesizing a state quantity in a normal facility and a state quantity in an abnormal facility in an apparatus such as a pressing machine that repeats the same work in a relatively short cycle. A determination apparatus of PTL 1 generates an alarm when a state quantity of a target device exceeds the determination value or falls below the determination value.

### CITATION LIST

### Patent Literature

PTL 1: Unexamined Japanese Patent Publication No. H9-120365

### SUMMARY OF THE INVENTION

A conventional art only allows an alarm to be generated when a state quantity of a target device exceeds a determination value or falls below the determination value, and thus cannot predict thickness or hardness of a workpiece.

The present disclosure provides an information processing device and an information processing method capable of estimating at least one of hardness and thickness of a workpiece.

An information processing device according to an aspect of the present disclosure includes a processor that estimates a state of a workpiece to be processed by a processing device that repeatedly performs processing, and a storage device that stores an operation parameter for estimating the state of the workpiece. The processor acquires waveform data indicating a measurement result of a transition of a processing load in a processing cycle by a processing device, and estimates at least one of hardness and thickness of the workpiece as the state of the workpiece based on a height of a waveform indicated by the waveform data, a width of the waveform, and the operation parameter.

An information processing method according to another aspect of the present disclosure is for estimating a state of a workpiece to be processed by a processing device that repeatedly performs processing, the information processing method including: acquiring waveform data indicating a measurement result of a transition of a processing load in a processing cycle by the processing device; and estimating at least one of hardness and thickness of the workpiece as the state of the workpiece based on a height of a waveform indicated by the waveform data, a width of the waveform, and an operation parameter for estimating the state of the workpiece.

The present disclosure enables estimating at least one of hardness and thickness of a workpiece.

### BRIEF DESCRIPTION OF THE DRAWINGS

FIG. 1 is a block diagram illustrating a configuration example of a workpiece state estimation device according to an exemplary embodiment of the present disclosure.

FIG. 2 is a schematic sectional view illustrating pressing machine 50 equipped with a load sensor and a distance sensor illustrated in FIG. 1.

FIG. 3 is a schematic graph illustrating an example of a load waveform measured by load sensor 11 and distance sensor 12.

FIG. 4 is a flowchart illustrating a procedure of workpiece state estimation processing performed by a CPU of the workpiece state estimation device of FIG. 1.

FIG. 5 is a flowchart illustrating operation parameter acquisition processing illustrated in FIG. 4.

FIG. 6 is a diagram illustrating a parameter correspondence table illustrating operation parameters corresponding to tool state parameters.

FIG. 7 is a graph illustrating a change appearing in a load waveform when workpiece hardness is constant and workpiece thickness changes.

FIG. 8 is a graph illustrating a change appearing in a load waveform when workpiece thickness is constant and workpiece hardness changes.

FIG. 9 is a graph illustrating a relationship between width and height of a load waveform, and workpiece thickness.

FIG. 10 is a graph illustrating a relationship between width and height of a load waveform, and workpiece thickness.

FIG. 11 is a graph illustrating a relationship between width and height of a load waveform, and workpiece hardness.

FIG. 12 is a graph illustrating a relationship between width and height of a load waveform, and workpiece hardness.

FIG. 13 is a diagram illustrating a parameter correspondence table according to a modification of an exemplary embodiment of the present disclosure.

FIG. 14 is a diagram for illustrating a method for determining height of a load waveform according to a modification of an exemplary embodiment of the present disclosure.

### DESCRIPTION OF EMBODIMENT

### (Underlying Knowledge on the Present Disclosure)

To enhance stability of processing quality, processing conditions of press working preferably can be changed depending on a workpiece state. Here, the “workpiece state” refers to at least one of thickness and hardness of the workpiece. To prevent decrease in processing efficiency, the workpiece state is preferably measured during processing (that is, in-line). Unfortunately, the conventional art has not disclosed measurement of the workpiece state in-line.

In particular, hardness of a workpiece is required to be measured by a Vickers hardness test as defined in JIS standard Z2244, for example. That is, the Vickers hardness test requires steps of cutting out a workpiece into a test piece, setting the test piece in a Vickers hardness meter as a tester, pressing the Vickers indenter against the workpiece with a predetermined test force and holding the test piece for a predetermined time, and measuring a size of a recess generated by the pressing with a microscope. Thus, in-line measurement of hardness of a workpiece continuously input to a pressing machine is difficult. In particular, when a workpiece to be input into the pressing machine has a coil shape, the workpiece cannot be cut out to be individually measured. Thus, in-line measurement of hardness of the workpiece is difficult.

The present inventors have found the following findings as a result of repeated studies to accurately estimate a workpiece state in punching with a pressing machine.

A load applied to a punch or a workpiece during punching depends on values such as thickness of the workpiece, hardness of the workpiece, the amount of wear of the punch, the amount of wear of a die, and a clearance. The thickness of the workpiece is in a punching direction, and is measured by a micrometer, a laser displacement meter, or the like, for example.

The amount of wear of the punch and the amount of wear of the die are indexes indicating a degree of wear of the punch and a degree of wear of the die, respectively. The amount of wear of a tool such as the amount of wear of the punch or the amount of wear of the die is represented by a dimensional change of the tool from a design value, for example. The amount of wear of a tool may be represented by the amount of change such as a shape change, a volume change, or a mass change. The amount of wear of a tool may be also represented by a radius of an arc when the wear is approximated as the arc.

The clearance is a gap between the die and the punch. For example, the clearance is a gap between the die and the punch when a punching hole is formed in the workpiece. The clearance may be represented by a ratio of the gap between the die and the punch to the thickness of the workpiece.

A load in the punching depends on these parameters. Thus, when the amount of wear of the punch, the amount of wear of the die, and the clearance are determined, parameters of a workpiece state are conceivable to be more simply estimated from a load waveform. For example, when the clearance is known as a design value and the amount of wear of the punch, the amount of wear of the die are determined from the number of times of punching or the like, for example, if the workpiece state can be estimated from the load waveform, setting suitable for the workpiece state can be performed in a step subsequent to the punching.

When the workpiece state can be estimated in-line for each processing cycle using the pressing machine, for example, the workpiece state does not need to be measured using a measuring machine provided at a place different from the pressing machine. The workpiece state measured in this manner can be used not only for traceability but also for process management by observing these trends.

Additionally, when the workpiece state can be estimated for each processing cycle, a variation of the workpiece state within a lot and between lots can be managed or displayed as a trend, and thus can be used for state management of the workpiece input to the pressing machine, process management, and process improvement by analyzing the variation of the workpiece state.

Estimating only the workpiece state is reasonable in a processing machine that performs cycle processing. One reason for the rationality is that parameters other than the workpiece state are more moderate than variations in thickness and hardness of the workpiece in processing of several tens of thousands of cycles or more, the parameters being variations in a tool state, such as a clearance, the amount of wear of a punch, the amount of wear of a die. For example, variations in the tool state such as the clearance, the amount of wear of the punch, the amount of wear of the die can be ignored within a range of a predetermined number of cycles. That is, change in a waveform generated within predetermined cycles can be said to be caused by a workpiece state. Based on these findings, the inventors have found that a workpiece state can be accurately estimated by capturing a variation of the workpiece state from a waveform within a range of processing cycles in which a variation of a tool state can be ignored, for example, thereby having reached the present disclosure.

Hereinafter, exemplary embodiments of the present disclosure will be described in detail with reference to the drawings appropriately. However, unnecessarily detailed description may be omitted. For example, detailed descriptions of already well-known matters and duplicated descriptions of substantially the same configuration may be omitted. This is to avoid an unnecessarily redundant description in the following description and to facilitate understanding of those skilled in the art. The inventors provide the attached drawings and the following description for those skilled in the art to fully understand the present disclosure, and thus do not intend that the attached drawings and the following description limit the subject matter described in the scope of claims.

### 1. CONFIGURATION

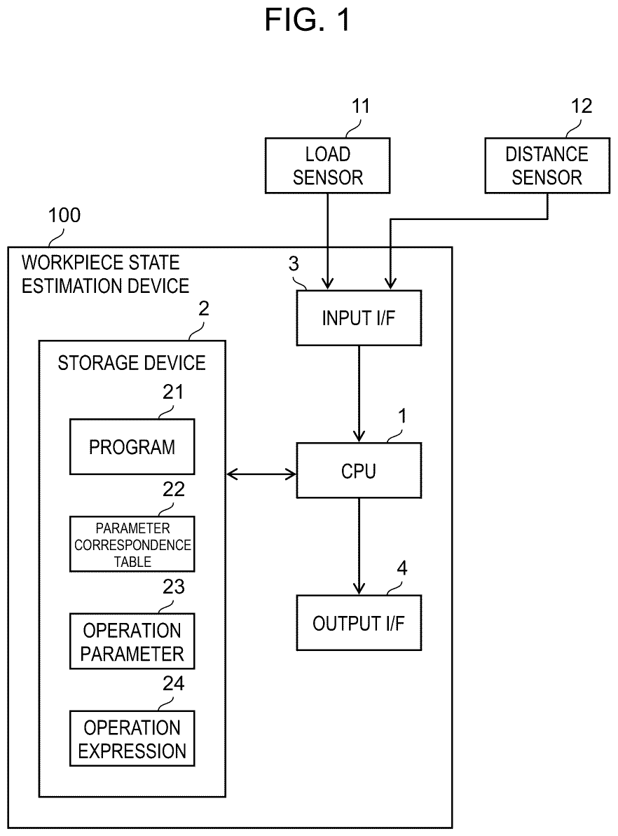

FIG. 1 is a block diagram illustrating a configuration example of workpiece state estimation device 100 according to an exemplary embodiment of the present disclosure. Workpiece state estimation device 100 is an example of an “information processing device” of the present disclosure. Workpiece state estimation device 100 includes CPU 1, storage device 2, input interface (I/F) 3, and output interface (I/F) 4.

CPU 1 performs information processing to implement estimation processing of workpiece state estimation device 100 described later. Such information processing is implemented by CPU 1 operating according to a command of program 21 stored in storage device 2, for example. CPU 1 is an example of a processor of the present disclosure. The processor may include an arithmetic circuit that performs an arithmetic operation for the information processing, and is not limited to the CPU. For example, the processor may include a circuit such as an MPU or an FPGA. Operation expression 24 may include a program for performing an arithmetic operation, or may be included in the program.

Storage device 2 is a recording medium that records various types of information including data described later, such as parameter correspondence table 22, operation parameter 23, and operation expression 24, and program 21 necessary for implementing estimation processing of workpiece state estimation device 100. Storage device 2 is implemented by a semiconductor storage device such as a flash memory or a solid state drive (SSD), a magnetic storage device such as a hard disk drive (HDD), or another recording medium, alone or in combination thereof, for example. Storage device 2 may include a volatile memory such as an SRAM or a DRAM.

Input interface 3 is an interface circuit that connects workpiece state estimation device 100 to an external device to input information such as results detected by load sensor 11 and distance sensor 12 to workpiece state estimation device 100. Such an external device is a device such as load sensor 11, distance sensor 12, or another information processing terminal, for example. Input interface 3 may be a communication circuit that performs data communication according to an existing wired communication standard or wireless communication standard.

Output interface 4 is an interface circuit that connects workpiece state estimation device 100 to an external output device to output information from workpiece state estimation device 100. Such an output device is a display or another information processing terminal, for example. Output interface 4 may be a communication circuit that performs data communication according to an existing wired communication standard or wireless communication standard. Input interface 3 and output interface 4 may be implemented by similar hardware.

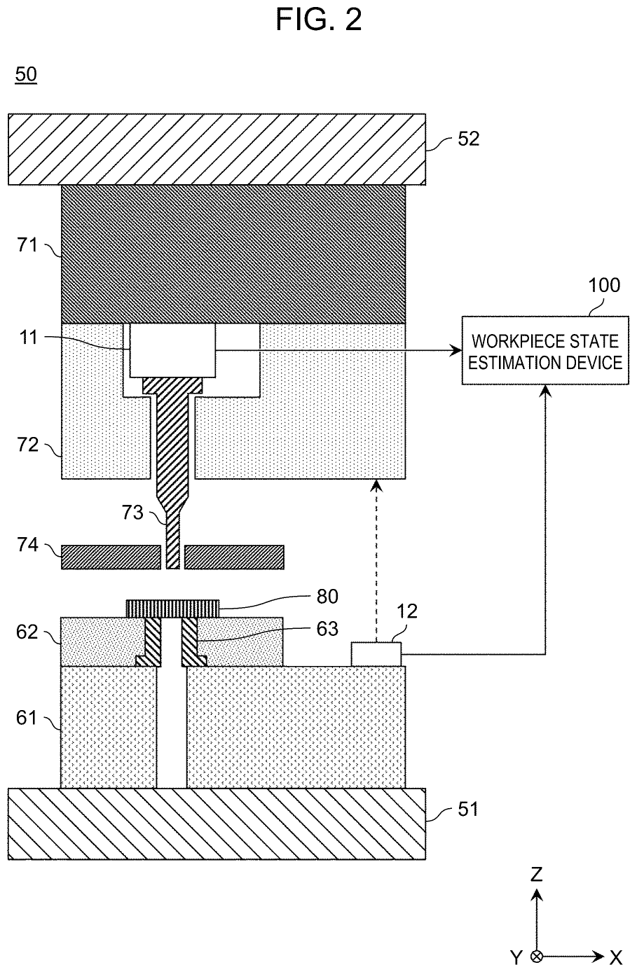

FIG. 2 is a schematic sectional view illustrating pressing machine 50 equipped with load sensor 11 and distance sensor 12 illustrated in FIG. 1. FIG. 2 illustrates an X-axis, a Y-axis, and a Z-axis orthogonal to each other for the sake of convenience of description. The Z-axis indicates the vertical direction.

Pressing machine 50 is an example of a processing machine that performs cycle processing of repeating the same processing. Pressing machine 50 includes bolster 51 and slide 52 that repeatedly performs an up-down cycle motion from a top dead center to a bottom dead center with respect to bolster 51. Die backing plate 61 is attached on bolster 51, and die plate 62 is attached on die backing plate 61. Die plate 62 grips die 63.

Punch backing plate 71 is attached to a lower portion of slide 52, and punch plate 72 is attached to a lower portion of punch backing plate 71. Punch plate 72 grips punch 73. Pressing machine 50 further includes stripper plate 74. Stripper plate 74 is attached to a fastener such as a bolt and punch plate 72 or punch backing plate 71 using a positioning guide such as a post (not illustrated), for example. Stripper plate 74 is pressed downward by a compression spring, for example, and has a function of guiding punch 73 to locate punch 73 at a constant position, a function of extracting a material attached to punch 73 after punching workpiece 80, and/or a function of fixing workpiece 80 at the time of punching workpiece 80.

Load sensor 11 is installed between punch 73 and punch backing plate 71, for example. Load sensor 11 is a piezoelectric force sensor, a semiconductor strain sensor, or an electric force sensor of a strain gauge type or the like, for example, and measures a load applied to punch 73 when punch 73 punches workpiece 80.

Distance sensor 12 is installed on die backing plate 61, for example. Distance sensor 12 is an eddy current type gap sensor or a laser displacement meter, for example, and measures a distance to punch plate 72 facing in the Z-axis direction, for example.

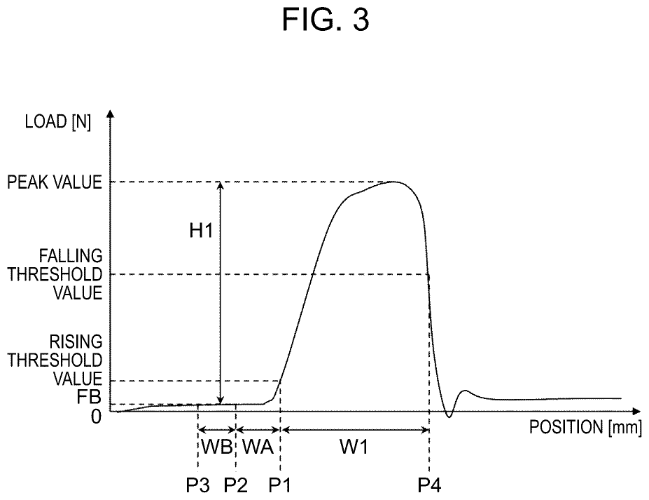

FIG. 3 is a schematic graph illustrating an example of a load waveform generated by a load measured by load sensor 11 and a distance measured by distance sensor 12. FIG. 3 illustrates the graph with a horizontal axis representing a position of punch 73 with respect to an initial position. Distance sensor 12 measures a position of punch 73. The horizontal axis of the graph of FIG. 3 can also be referred to as a distance by which punch 73 has proceeded in a negative direction of the Z-axis.

FIG. 3 illustrates the graph with a vertical axis representing a load measured by load sensor 11. The graph in FIG. 3 indicates a mountainous waveform in which a load starts to be applied to workpiece 80, that is, punch 73 and load sensor 11, from a time point when punch 73 is lowered to come into contact with workpiece 80 in punching, and the load rapidly decreases to near zero after workpiece 80 is punched out.

Punching start timing of the punching can be measured based on a position at which a load exceeds a rising threshold value in a load waveform, for example. Such a rising threshold value may be determined as an absolute value or may be determined as a ratio of the load to a peak value.

### 2. OPERATION

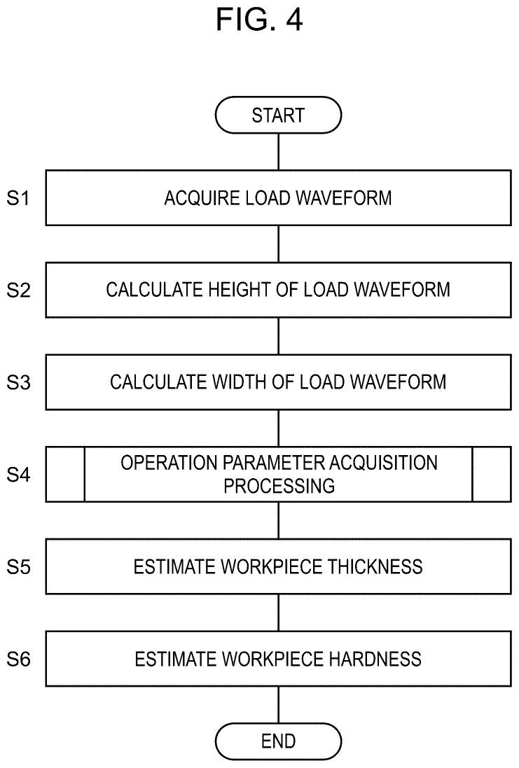

With reference to FIGS. 4 to 6, an outline of estimation processing of a workpiece state will be described.

FIG. 4 is a flowchart illustrating a procedure of the estimation processing of a workpiece state using CPU 1 of workpiece state estimation device 100 of FIG. 1.

First, CPU 1 acquires load data from load sensor 11, the load data indicating a load applied to load sensor 11 during press working with pressing machine 50. CPU 1 acquires position data indicating a position from distance sensor 12. CPU 1 acquires a load waveform indicating measurement results of the load and the position from the load data and the position data (S1).

Next, CPU 1 calculates a height of the load waveform acquired in step S1 (S2). In the present exemplary embodiment, height H1 of the load waveform is acquired as a difference between a value of the load before punching starts and a peak value of the load.

Description with reference to FIG. 3 shows that CPU 1 obtains position P2 before punch 73 advances from position P1 by WA with reference to position P1 at which a load becomes equal to the rising threshold value, for example. CPU 1 obtains position P3 further before position P2 by WB. CPU 1 calculates an average of loads from position P3 to position P2 as reference load FB. CPU 1 determines a difference between the peak value of the loads and reference load FB as height H1 of the load waveform.

When punch 73 moves in the Z direction, sliding resistance is generated on punch 73 by being guided by stripper plate 74, and the sliding resistance is measured as a load. Thus, height H1 can be accurately acquired by setting the difference between the load average (reference load FB) and the peak load in section WB as height H1 of the load waveform.

Returning to FIG. 4, CPU 1 calculates a width of the load waveform acquired in step S1 (S3). In the present exemplary embodiment, width W1 of the load waveform is represented as a difference between position P1 where the load waveform exceeds the rising threshold value and position P4 where the load waveform falls below a falling threshold value in FIG. 3, for example. Such a rising threshold value and a falling threshold value may be each determined as an absolute value or a ratio of a load to a peak value. Additionally, the rising threshold value and the falling threshold value may be each set to the same value or a different value. Width W1 of the load waveform may be acquired as a half-value width of the load waveform.

Returning to FIG. 4, CPU 1 performs operation parameter acquisition processing of acquiring operation parameter 23 for estimating hardness and thickness of workpiece 80 from the height and the width of the load waveform (S4).

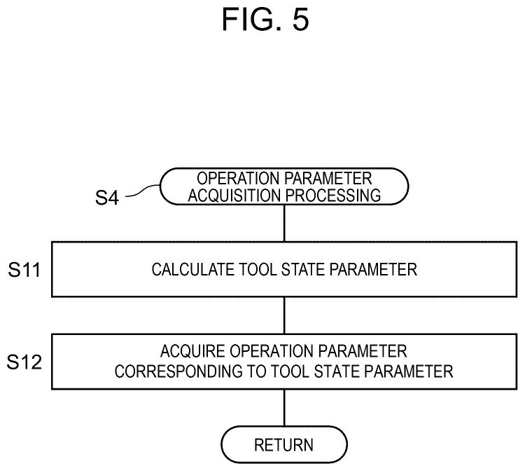

FIG. 5 is a flowchart illustrating operation parameter acquisition processing S4 illustrated in FIG. 4. In operation parameter acquisition processing S4, CPU 1 first calculates a tool state parameter (S11). In step S11, CPU 1 may estimate roughly the tool state parameter.

The tool state parameter represents a degree of wear of tools such as punch 73 and die 63. Examples of the tool state parameter include the number of times of punching of workpiece 80 after at least one of punch 73 and die 63 is polished, repolished, or replaced. The amount of wear of tools such as punch 73 and die 63 progresses as the number of times of punching increases, so that the number of times of punching can represent a degree of wear of the tools. When the tool state parameter, such as a parameter corresponding to the number of times of punching, is used, CPU 1 can more accurately estimate the hardness and the thickness of workpiece 80.

Next, CPU 1 acquires operation parameter 23 corresponding to the tool state parameter acquired in step S11 (S12).

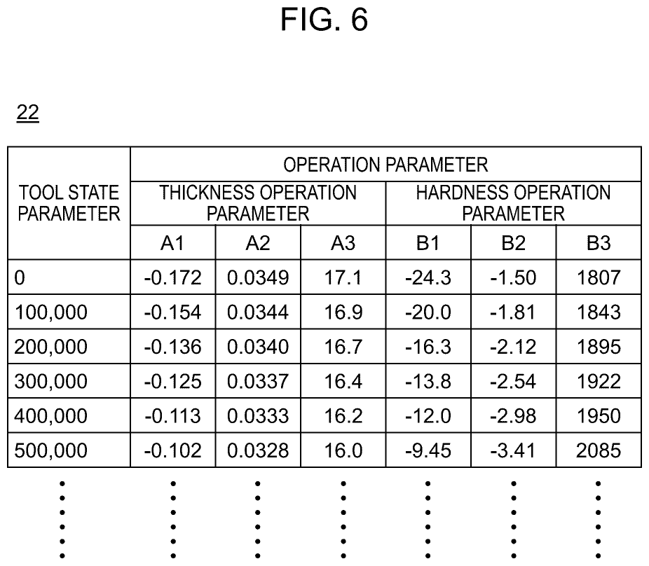

FIG. 6 is a diagram illustrating parameter correspondence table 22 illustrating operation parameters 23 corresponding to tool state parameters. Parameter correspondence table 22 is stored in advance in storage device 2, for example. For example, CPU 1 acquires a value of the operation parameter corresponding to a value of the tool state parameter from parameter correspondence table 22. Parameter correspondence table 22 illustrated in FIG. 6 defines the tool state parameter in units of 100,000 steps. Operation parameter 23 includes thickness operation parameters A1, A2, and A3 related to the thickness (workpiece thickness) of workpiece 80 and hardness operation parameters B1, B2, and B3 related to the hardness (workpiece hardness) of workpiece 80.

When the tool state parameter corresponding to the current number of times of punching is more than or equal to the tool state parameter of a specific row (n-th row) in parameter correspondence table 22 and does not exceed the value of the tool state parameter of the next row (“n+1”-th row), CPU 1 acquires the value of the operation parameter of the specific row (n-th row).

Returning to FIG. 5, when step S12 is finished, CPU 1 returns the acquired value of operation parameter 23 and finishes operation parameter acquisition processing S4. Operation parameter 23 is stored in storage device 2, for example.

Returning to FIG. 4, CPU 1 estimates workpiece thickness (S5). In step S5, CPU 1 performs an operation for estimating the workpiece thickness based on height H1 of the load waveform calculated in step S2, width W1 of the load waveform calculated in step S3, and thickness operation parameters A1, A2, and A3 acquired in step S4. For example, workpiece thickness T is estimated by Expression (1) below.

T=A1×H1+A2×W1+A3 (1)

Next, CPU 1 estimates workpiece hardness (S6). In step S6, CPU 1 performs an operation for estimating the workpiece hardness based on height H1 of the load waveform calculated in step S2, width W1 of the load waveform calculated in step S3, and hardness operation parameters B1, B2, and B3 acquired in step S4. For example, workpiece hardness V is estimated by Expression (2) below.

V=B1×H1+B2×W1+B3 (2)

Operation expression 24 including information indicating Expressions (1) and (2) is stored in storage device 2 in advance, for example.

The order of steps S5 and S6 is not limited to the order illustrated in FIG. 4, and step S6 may be performed before step S5.

As described above, CPU 1 can estimate workpiece thickness T and workpiece hardness V. CPU 1 ends the flow of FIG. 4 by outputting acquired workpiece thickness T and hardness V as a workpiece state, for example. Workpiece state estimation device 100 may display a workpiece state value in the current processing to a user, or may display a trend as a graph. Consequently, the user can adjust processing conditions as necessary by referring to the workpiece state value.

### 3. PRINCIPLE OF ESTIMATING WORKPIECE THICKNESS AND WORKPIECE HARDNESS

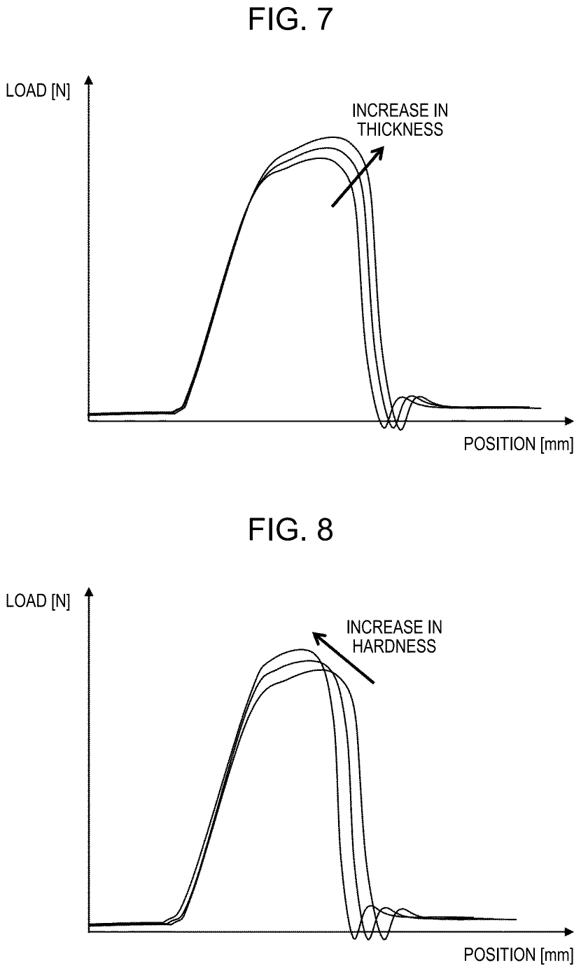

Hereinafter, a principle enabling workpiece thickness and workpiece hardness to be estimated by the above method will be described. FIG. 7 is a graph illustrating a change appearing in a load waveform when workpiece hardness is constant and workpiece thickness changes. FIG. 8 is a graph illustrating a change appearing in a load waveform when workpiece thickness is constant and workpiece hardness changes.

As illustrated in FIGS. 7 and 8, appearance of the width and height of the load waveform is different in trend between when the workpiece thickness changes and when the workpiece hardness changes.

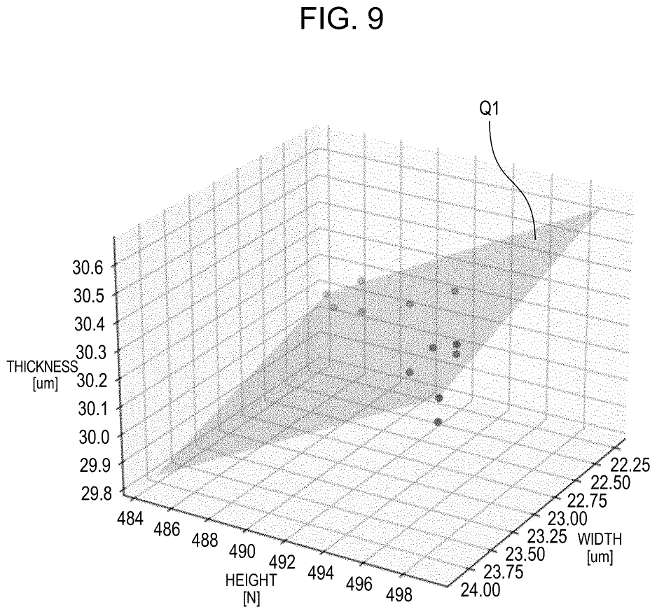

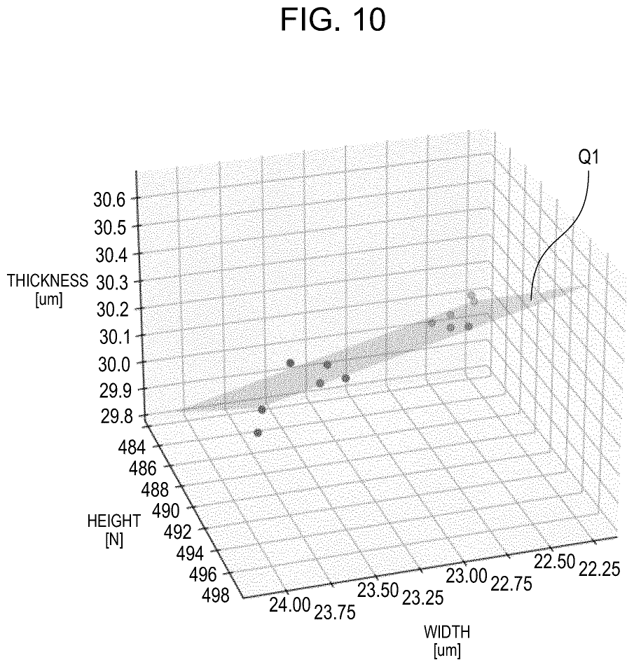

As illustrated in FIGS. 9 and 10, the inventors further have found a correlation between the width and height of the load waveform, and the workpiece thickness, and a correlation between the width and height of the load waveform, and the workpiece hardness.

FIG. 9 is a graph illustrating a relationship between width and height of a load waveform, and workpiece thickness. The width and height of the load waveform in FIG. 9 are data calculated by a calculation method according to the present exemplary embodiment (e.g., steps S2 and S3 in FIG. 4) based on a load waveform measured by load sensor 11 during press working of workpiece 80 with pressing machine 50. The thickness data in FIG. 9 is acquired by measuring thickness of workpiece 80 before or after the press working. FIG. 9 illustrates 12 pieces of data acquired in this manner.

FIG. 10 illustrates a graph acquired by rotating the graph of FIG. 9, in which the 12 pieces of data illustrated in FIG. 9 are viewed from an angle different from that in FIG. 9.

FIGS. 9 and 10 reveal that the 12 pieces of data are distributed along plane Q1, the data indicating the relationship between the width and height of the load waveform, and the workpiece thickness. Thus, the width and height of the load waveform, and the workpiece thickness can be said to correlate with each other.

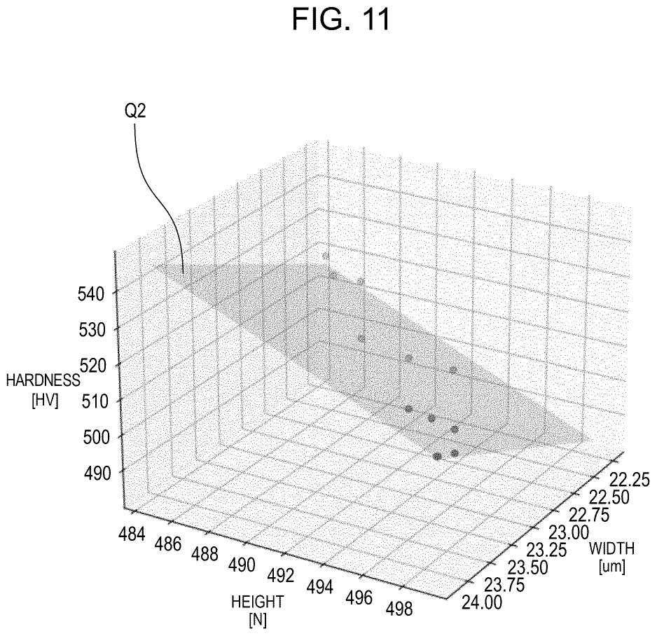

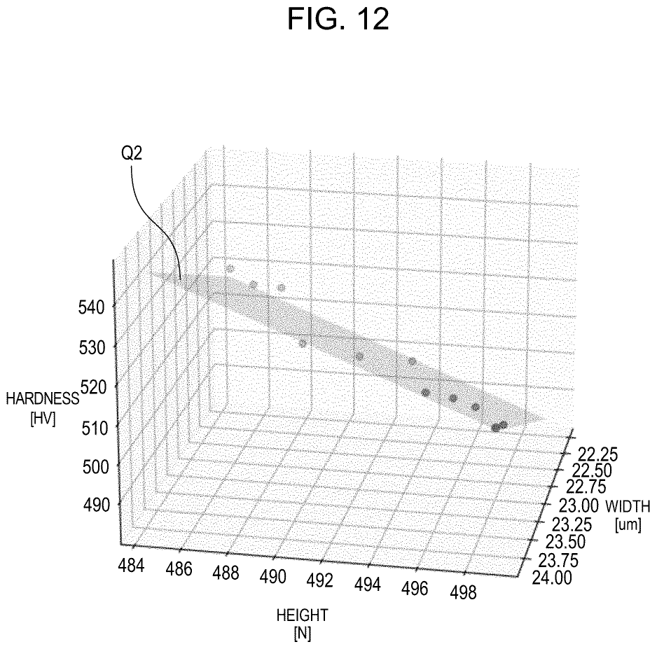

FIG. 11 is a graph illustrating a relationship between width and height of a load waveform, and workpiece hardness. The hardness data in FIG. 11 is acquired by measuring hardness of workpiece 80 after the press working. FIG. 11 illustrates 11 pieces of data acquired in this manner. FIG. 12 illustrates a graph acquired by rotating the graph of FIG. 11, in which the 11 pieces of data illustrated in FIG. 11 are viewed from an angle different from that in FIG. 11.

FIGS. 11 and 12 reveal that the 11 pieces of data are distributed along plane Q2, the data indicating the relationship between the width and height of the load waveform, and the workpiece hardness. Thus, the width and height of the load waveform, and the workpiece hardness can be said to correlate with each other.

Thus, workpiece state estimation device 100 according to the present exemplary embodiment can acquire workpiece thickness and workpiece hardness based on a height and a width of a load waveform by Expressions (1) and (2) using operation parameter 23 representing a trend of each of the workpiece thickness and the workpiece hardness.

### 4. MODIFICATIONS

As described above, the exemplary embodiments have been described as examples of the technique in the present disclosure. However, the techniques in the present disclosure are not limited to the above exemplary embodiment and can also be applied to an exemplary embodiment in which modification, replacement, addition, removal, or the like is performed appropriately. Additionally, the components described in the above exemplary embodiments can be combined to form a new exemplary embodiment. Thus, modifications as other exemplary embodiments will be described below.

### 4-1. First Modification

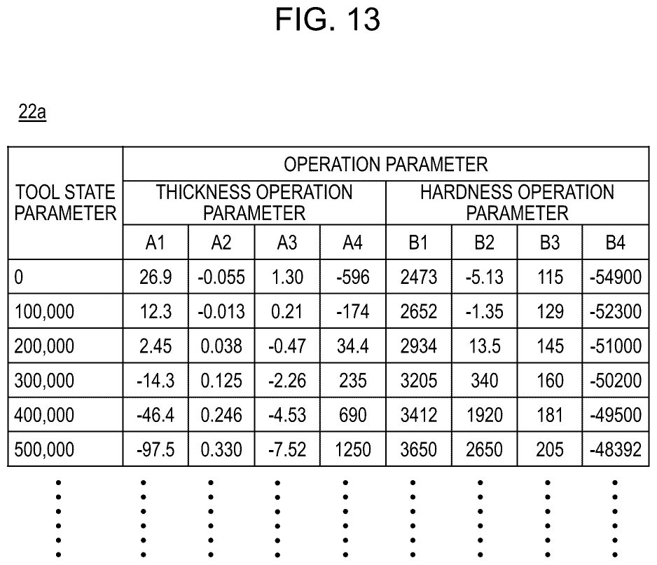

The above exemplary embodiments have been described with an example in which the thickness operation parameter and the hardness operation parameter each include three parameters (see FIG. 6). However, the number of parameters included in the thickness operation parameter and the hardness operation parameter is not limited to three. For example, each of the thickness operation parameter and the hardness operation parameter may include four parameters as illustrated in parameter correspondence table 22a of FIG. 13.

In the present modification, CPU 1 estimates workpiece thickness based on thickness operation parameters A1, A2, A3, and A4 (see S5 in FIG. 4), and estimates workpiece hardness based on hardness operation parameters B1, B2, B3, and B4 (see S6 in FIG. 4). For example, workpiece thickness T is estimated by Expression (3) below, and workpiece hardness V is estimated by Expression (4) below.

T=A1×H1+A2×H1×W1+A3×W1+A4 (3)

V=B1×H1+B2×H1×W1+B3×W1+B4 (4)

Although workpiece thickness T is linear with respect to height H1 and width W1 of the load waveform in Expression (1) according to the above exemplary embodiment, workpiece thickness T is nonlinear with respect to H1 and W1 in Expression (3). Similarly, workpiece hardness V is nonlinear with respect to H1 and W1 in Expression (4).

According to the present modification, even workpiece thickness T and/or workpiece hardness V being nonlinear with respect to height H1 and width W1 of a load waveform depending on a material of workpiece 80 enables a workpiece state to be estimated by an operation. Thus, the workpiece state can be accurately estimated for workpieces made of more various materials.

### 4-2. Second Modification

The above exemplary embodiments have been described with an example in which the difference between reference load FB and the peak load is set to height H1 of the load waveform in step S2 of calculating height H1 of a load waveform (see FIG. 3). However, a method for determining height H1 of the load waveform is not limited to the example.

For example, CPU 1 may determine a peak load of the load waveform as height H1. This configuration enables acquiring height H1 of the load waveform without deteriorating accuracy while reducing the amount of operation required for CPU 1 for a gap between punch 73 and stripper plate 74, the gap being sufficient to cause no sliding resistance.

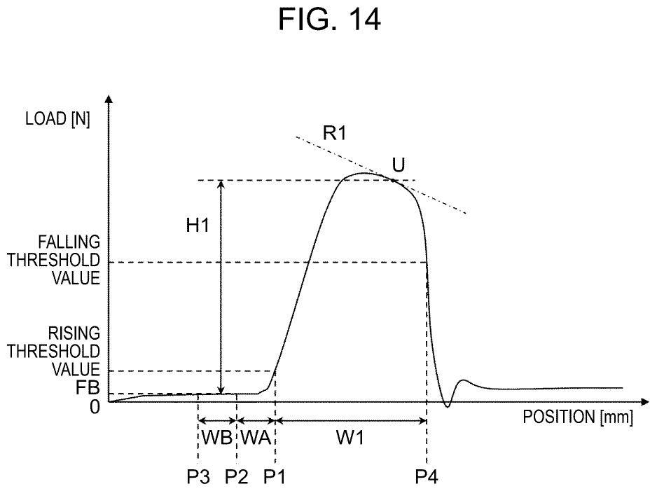

Alternatively, CPU 1 may determine a difference between reference load FB and a load value at point U, at which a load waveform has designated gradient R1, as height H1 of the load waveform as illustrated in FIG. 14. FIG. 14 illustrates a straight line with a gradient of R1 with an alternate long and short dash line. Point U indicates a first point where the gradient becomes R1 after a position where a load exceeds the rising threshold value in the load waveform.

A measured load waveform may be different in shape due to a difference in material of workpiece 80, a difference in a tool state parameter, or the like. When workpiece thickness and workpiece hardness change, a height of a load waveform may not be a difference between a peak value and a predetermined value, the height being desirably used to accurately estimate a workpiece state. The present modification enables accurate estimation of a workpiece state even when a load waveform changes in shape by using a load value at point U where the load waveform has designated gradient R1.

### 4-3. Third Modification

The above exemplary embodiments have been described with an example in which CPU 1 estimates workpiece thickness and workpiece hardness from a height and a width of a load waveform. However, workpiece state estimation device 100 according to the present disclosure may be configured to estimate at least one of the workpiece thickness and the workpiece hardness.

### 4-4. Fourth Modification

The above exemplary embodiments have been described with an example in which operation expressions (1) to (4) for estimating workpiece thickness T and workpiece hardness V are each a linear expression. However, an operation expression is not limited to the linear expression. For example, the operation expression may be a quadratic expression, or a cubic or higher order expression. This configuration enables estimation of workpiece thickness and/or workpiece hardness based on a more complicated nonlinear relationship depending on material of workpiece 80.

### 4-5. Fifth Modification

The above exemplary embodiments have been described with an example in which a load waveform is acquired as a function of a position as illustrated in FIG. 3. However, the load waveform may be acquired as a function of time. Cycle processing using general pressing machine 50 is controlled by pressing machine 50 to cause slide 52 to always move up and down at a constant cycle. Thus, even when the horizontal axis of the load waveform represents time instead of the position, the estimation of a workpiece state of the present disclosure can be performed. This configuration enables estimation of workpiece thickness and/or workpiece hardness with a simpler configuration without requiring distance sensor 12.

### 4-6. Sixth Modification

The above exemplary embodiments have been described with an example in which a tool state parameter is the number of times of punching of workpiece 80 after at least one of punch 73 and die 63 is polished, repolished, or replaced. However, the tool state parameter is not limited to the example.

For example, the tool state parameter may be the amount of wear of punch 73. For example, the amount of wear of the punch can be determined by measurement or estimation. This configuration enables estimation of workpiece thickness and/or workpiece hardness using a more accurate operation parameter based on the amount of wear of the punch.

Alternatively, the tool state parameter may be a two-dimensional parameter related to the amount of wear of punch 73 and the amount of wear of die 63. For example, the amount of wear of the punch and the amount of wear of the die can be determined by measurement or estimation. This configuration enables estimation of workpiece thickness and/or workpiece hardness using a more accurate operation parameter based on the amount of wear of the punch and the amount of wear of the die.

### 5. EFFECTS AND OTHERS

As described above, workpiece state estimation device 100, which is an example of the information processing device according to the present disclosure, includes CPU 1 that estimates a state of a workpiece to be processed by pressing machine 50 that repeatedly performs press processing, and storage device 2 that stores operation parameter 23 for estimating the state of the workpiece. CPU 1 acquires waveform data indicating a measurement result of transition of a processing load in a processing cycle using pressing machine 50 (S1). CPU 1 estimates at least one of hardness and thickness of the workpiece as the state of the workpiece based on a height of a waveform indicated by the waveform data, a width of the waveform, and operation parameter 23 (S5, S6). This configuration enables workpiece state estimation device 100 to estimate at least one of the hardness and the thickness of the workpiece.

Operation parameter 23 includes a hardness operation parameter indicating a correlation between the height and width of the waveform, and the hardness of the workpiece, and CPU 1 may estimate the hardness of the workpiece based on the height of the waveform, the width of the waveform, and the hardness operation parameter (S6).

Operation parameter 23 includes a thickness operation parameter indicating a correlation between the height and width of the waveform and the thickness of the workpiece, and CPU 1 may estimate the thickness of the workpiece based on the height of the waveform, the width of the waveform, and the thickness operation parameter (S5).

Operation parameter 23 may include a tool state parameter representing a degree of wear of a tool of pressing machine 50 in a plurality of stages and a parameter corresponding to the tool state parameter in each stage. In processing of estimating at least one of the hardness and the thickness of the workpiece, CPU 1 determines the tool state parameter (S11) and acquires a parameter corresponding to the determined tool state parameter from storage device 2 (S12). CPU 1 estimates at least one of the hardness and the thickness of the workpiece using the acquired parameters. This configuration enables performing more accurate estimation in accordance with the degree of wear of the tool.

CPU 1 may acquire a difference between position P1 or time at which the waveform exceeds the predetermined rising threshold value and position P4 or time at which the waveform falls below the predetermined falling threshold value to determine the difference as the width of the waveform. CPU 1 may determine the height of the waveform based on a value of a load at a peak of the waveform.

CPU 1 may determine the height of the waveform based on a value of a load at a point where a part of the waveform exceeding the predetermined rising threshold value has predetermined gradient R1. This configuration enables accurate estimation of a workpiece state even when a load waveform changes in shape by using a value of a load at point U where the load waveform has designated gradient R1.

### 6. ASPECT EXAMPLES

Hereinafter, aspects of the present disclosure will be exemplified.

### Aspect 1

An information processing device including:
a processor that estimates a state of a workpiece to be processed by a processing device that repeatedly performs processing; and
a storage device that stores an operation parameter for estimating the state of the workpiece,
in which
the processor acquires waveform data indicating a measurement result of a transition of a processing load in a processing cycle by a processing device, and
the processor estimates at least one of hardness and thickness of the workpiece as the state of the workpiece based on a height of a waveform indicated by the waveform data, a width of the waveform, and the operation parameter.

### Aspect 2

The information processing device described in Aspect 1, in which
the operation parameter includes a hardness operation parameter indicating a correlation between the height and the width of the waveform, and hardness of the workpiece, and the processor estimates the hardness of the workpiece based on the height of the waveform, the width of the waveform, and the hardness operation parameter.

### Aspect 3

The information processing device described in Aspect 1 or 2, in which
the operation parameter includes a thickness operation parameter indicating a correlation between the height and the width of the waveform, and thickness of the workpiece, and
the processor estimates the thickness of the workpiece based on the height of the waveform, the width of the waveform, and the thickness operation parameter.

### Aspect 4

The information processing device described in any one of Aspects 1 to 3, in which
the storage device further stores a tool state parameter representing a degree of wear of a tool of the processing device in a plurality of stages,
the operation parameter includes a plurality of parameter values corresponding to the plurality of stages of the tool state parameter,
the processor is configured to estimate the at least one of the hardness and the thickness of the workpiece by:
   determining one stage of the plurality of stages of the tool state parameter;
   acquiring one parameter value of the plurality of parameter values of the operation parameter from the storage device, the one parameter value corresponding to the one stage; and
   estimating the at least one of the hardness and the thickness of the workpiece using the one parameter value.

### Aspect 5

The information processing device described in any one of Aspects 1 to 4, in which the processor determines, as the width of the waveform, a difference between a position or time at which the waveform exceeds a predetermined rising threshold value and a position or time at which the waveform falls below a predetermined falling threshold value.

### Aspect 6

The information processing device described in any one of Aspects 1 to 5, in which the processor determines the height of the waveform based on a value of the processing load at a peak of the waveform.

### Aspect 7

The information processing device described in any one of Aspects 1 to 5, in which
the waveform includes a part which exceeds a predetermined rising threshold, and
the processor determines the height of the waveform based on a value of the processing load at a point where the part of the waveform has a predetermined gradient.

### Aspect 8

The information processing device described in any one of Aspects 1 to 7, in which the processing device is a pressing machine.

### Aspect 9

The information processing device described in any one of Aspects 1 to 8, in which the processor outputs the at least one of the estimated hardness of the workpiece and the estimated thickness of the workpiece.

### Aspect 10

The information processing device described in any one of Aspects 1 to 9, in which the processor receives a change in processing conditions of the processing device.

### Aspect 11

An information processing method for estimating a state of a workpiece to be processed by a processing device that repeatedly performs processing, the information processing method including:
acquiring waveform data indicating a measurement result of a transition of a processing load in a processing cycle by the processing device; and
estimating at least one of hardness and thickness of the workpiece as the state of the workpiece based on a height of a waveform indicated by the waveform data, a width of the waveform, and an operation parameter for estimating the state of the workpiece.

### Aspect 12

The information processing method described in Aspect 11, in which the processing device is a pressing machine.

### INDUSTRIAL APPLICABILITY

The present disclosure is applicable to a pressing machine.

### REFERENCE MARKS IN THE DRAWINGS

1 CPU (processor)
2 storage device
3 input interface
4 output interface
11 load sensor
12 distance sensor
21 program
22 parameter correspondence table
23 operation parameter
24 operation expression
50 pressing machine
51 bolster
52 slide
61 die backing plate
62 die plate
63 die
71 punch backing plate
72 punch plate
73 punch
74 stripper plate
80 workpiece
100 workpiece state estimation device (information processing device)

1. An information processing device comprising:
a processor that estimates a state of a workpiece to be processed by a processing device that repeatedly performs processing; and
a storage device that stores an operation parameter for estimating the state of the workpiece,
wherein
the processor acquires waveform data indicating a measurement result of a transition of a processing load in a processing cycle by a processing device, and
the processor estimates at least one of hardness and thickness of the workpiece as the state of the workpiece based on a height of a waveform indicated by the waveform data, a width of the waveform, and the operation parameter.

2. The information processing device according to claim 1, wherein
the operation parameter includes a hardness operation parameter indicating a correlation between the height and the width of the waveform, and hardness of the workpiece, and
the processor estimates the hardness of the workpiece based on the height of the waveform, the width of the waveform, and the hardness operation parameter.

3. The information processing device according to claim 1, wherein
the operation parameter includes a thickness operation parameter indicating a correlation between the height and the width of the waveform, and thickness of the workpiece, and
the processor estimates the thickness of the workpiece based on the height of the waveform, the width of the waveform, and the thickness operation parameter.

4. The information processing device according to claim 1, wherein
the storage device further stores a tool state parameter representing a degree of wear of a tool of the processing device in a plurality of stages,
the operation parameter includes a plurality of parameter values corresponding to the plurality of stages of the tool state parameter,
the processor is configured to estimate the at least one of the hardness and the thickness of the workpiece by:
determining one stage of the plurality of stages of the tool state parameter;
acquiring one parameter value of the plurality of parameter values of the operation parameter from the storage device, the one parameter value corresponding to the one stage; and
estimating the at least one of hardness and thickness of the workpiece using the one parameter value.

5. The information processing device according to claim 1, wherein the processor determines, as the width of the waveform, a difference between a position or time at which the waveform exceeds a predetermined rising threshold value and a position or time at which the waveform falls below a predetermined falling threshold value.

6. The information processing device according to claim 1, wherein the processor determines the height of the waveform based on a value of the processing load at a peak of the waveform.

7. The information processing device according to claim 1, wherein
the waveform includes a part which exceeds a predetermined rising threshold, and
the processor determines the height of the waveform based on a value of the processing load at a point where the part of the waveform has a predetermined gradient.

8. The information processing device according to claim 1, wherein the processing device is a pressing machine.

9. The information processing device according to claim 1, wherein the processor outputs the at least one of the estimated hardness of the workpiece and the estimated thickness of the workpiece.

10. The information processing device according to claim 1, wherein the processor receives a change in processing conditions of the processing device.

11. An information processing method for estimating a state of a workpiece to be processed by a processing device that repeatedly performs processing, the information processing method comprising:
acquiring waveform data indicating a measurement result of a transition of a processing load in a processing cycle by the processing device; and
estimating at least one of hardness and thickness of the workpiece as the state of the workpiece based on a height of a waveform indicated by the waveform data, a width of the waveform, and an operation parameter for estimating the state of the workpiece.

12. The information processing method according to claim 11, wherein the processing device is a pressing machine.
